(19) United States
(12) Patent Application Publication
(10) Pub. No.: US 2011/0022368 A1
(43) Pub. Date: Jan. 27, 2011

(54) SYSTEM AND METHOD FOR WELL PERFORMANCE OPTIMIZATION

(75) Inventors: Wann Sheng Huang, Houston, TX (US); Liang-Biao Ouyang, Bellaire, TX (US); Suk Kyoon Choi, Katy, TX (US)

Correspondence Address: CHEVRON CORPORATION, P.O. BOX 6006, SAN RAMON, CA, 94583-0806, US

(73) Assignee: Chevron U.S.A. Inc., San Ramon, CA (US)

(21) Appl. No.: 12/840,873

(22) Filed: Jul. 21, 2010

Related U.S. Application Data
(60) Provisional application No. 61/227,290, filed on Jul. 21, 2009.

(51) Int. Cl. G06G 7/48; G06F 19/00

(52) U.S. Cl. 703/10; 702/6

(57) ABSTRACT

A system, software program, and method to evaluate the performance of a well in a subsurface reservoir are disclosed. A new well module is used to evaluate new wells to be placed in fluid communication with the subsurface reservoir. An existing well module is used to evaluate existing wells that are in fluid communication with the subsurface reservoir. Wells can be evaluated to calculate performance characteristics, optimize performance, resolve any associated performance issues, or a combination thereof. A well screening module is used to quickly calculate properties of a well. A visual display is used to display outputs from the new well module, the existing well module, or the well screening module.

### CROSS-REFERENCE TO RELATED APPLICATION

The present application for patent claims the benefit of U.S. Provisional Application bearing Ser. No. 61/227,290, filed on Jul. 21, 2009, which is incorporated by reference in its entirety.

### TECHNICAL FIELD

The present invention is generally directed to enhancing the performance of a well in a subsurface reservoir, and more particularly, to a system and method for use in evaluating, predicting and optimizing well performance in a subsurface reservoir.

### BACKGROUND

Optimizing the development of new reservoir fields and efficiently managing production of current fields are of great significance in the petroleum industry, as capital expenses related to drilling and completing a well can be extremely high and production targets are becoming ever-more-aggressive. As a result, a large amount of effort has been dedicated to developing tools for evaluating subsurface reservoirs, such that educated predictions can be made to more accurately characterize fluid flow within the reservoirs and optimize the production of a well.

Geological models of subsurface reservoirs are built using data from various sources including seismic images, cores, production logs, down-hole well measurements, drilling information, and outcrops. These models typically contain rock properties such as permeability distributions and porosity distributions, as well as, fluid properties such as fluid saturation distributions. These properties or parameters can be used in mathematical relations, such as Darcy's Law and the mass conservation equation, to describe fluid flow within the reservoir and to quantify the pressure and flux of a reservoir. Similarly, rock parameters such as elastic and plastic rigidity can be used in Hooke's Law to quantify the displacement, stress and internal energy of a reservoir. Geological models can be simulated under different sets of circumstances to find optimal production techniques. For example, the location of a well or the well type can be varied to optimize hydrocarbon recovery. Many computer-implemented software programs used for constructing and simulating such geological models are currently available within the industry.

A suite of tools are also commercially available that can be utilized in evaluating and optimizing well configurations. Typically these tools utilize parameters of the reservoir model to determine the most appropriate well design. For example, certain applications may be directed at optimizing the completion of a well to accommodate a given wellbore based upon particular reservoir drainage conditions. One such available program is PROSPER, which is a well performance, design and optimization software program, distributed by Petroleum Experts Ltd. headquartered in Edinburgh, Scotland, United Kingdom.

While many reservoir characterization and well evaluation software tools are currently available, the experience of an operator often dictates the approach taken to solve a particular well problem. For example, a novice operator may determine what approach is taken based on a few prominent reservoir conditions, giving little or no attention to less prominent reservoir conditions. This can lead to a loss of reliability and productivity of the wellbore, as all relevant reservoir parameters are not considered in characterizing a well. Accordingly, there exists a need for a reliable and efficient methodology in which reservoir and well properties can be established in one computerized operation, such that sensible and practical solutions are obtained for well performance evaluation.

### SUMMARY

According to an aspect of the present invention, a system is disclosed to evaluate a well that is in fluid communication with a subsurface reservoir. The system includes a user control interface, a database, a computer processor, a software program, and a visual display. The user control interface is used to input information into the system such as geological characteristics of the subsurface reservoir, properties of fluid contained within the subsurface reservoir, data associated with an existing well that is in fluid communication with the subsurface reservoir, or a combination thereof. The database is configured to store data inputted into the system by the user control interface and outputted from the software program. The computer processor is configured to receive the stored data from the database and to execute software program. The software program includes a new well module, an existing well module, and a well screening module. The new well module can be used to evaluate the performance of a new well to be placed in fluid communication with the subsurface reservoir. The existing well module can be used to evaluate the performance of an existing well that is in fluid communication with the subsurface reservoir. The well screening module can be used to calculate a property of the existing well. The visual display is used to display outputs from the software program such as from the new well module, the existing well module, the well screening module, or a combination thereof.

In one embodiment, evaluating the new well using the new well module includes defining the new well as a horizontal, vertical, directional, or multilateral well. Zonal isolation and a completion types are also defined for the new well. The performance of the new well can then be forecasted. In one embodiment, an economic evaluation can be performed for the new well.

In one embodiment, the stored data includes data associated with the existing well. For example, the stored data can include well performance data, well design and completion information, documented procedural information, or a combination thereof. In one embodiment, the existing well module can forecast the performance of the existing well using the stored data. In one embodiment, the existing well module can optimize the performance of the existing well using the stored data. In one embodiment, the existing well module can identify a performance issue associated with the existing well based on the stored data and provide a recommendation for resolving the performance issue associated with the existing well. For example, the recommendation can be a list of technical consultants to help evaluate the performance issue associated with the existing well, a modification to the existing well, or a combination thereof.

In one embodiment, calculating the property of the existing well using the well screening module includes calculating productivity improvement ratios, production indexes, skin calculations, screen erosion predictions, sanding predictions, or a combination thereof.

In one embodiment, the output displayed by the visual display includes a result to a performance evaluation of the new well, a result to an economic evaluation of the new well, a result to a performance evaluation of the existing well, a calculated property of the existing well, recommendations to resolve a performance issue associated with the existing well, recommendations to optimize the performance of the existing well, or a combination thereof.

Another aspect of the present invention includes a software program for use in conjunction with a computer having a processor unit. The software program is stored on a readable storage medium and has instructions executable by the processor unit encoded thereon. The software program includes a new well module, an existing well module, and a well screening module. The new well module can be used to evaluate the performance of a new well to be placed in fluid communication with the subsurface reservoir. The existing well module can be used to evaluate the performance of an existing well that is in fluid communication with the subsurface reservoir. The well screening module can be used to calculate a property of the existing well.

In one embodiment, evaluating the new well using the new well module includes defining the new well as a horizontal, vertical, directional, or multilateral well. Zonal isolation and a completion types are also defined for the new well. The performance of the new well can then be forecasted. In some embodiments, an economic evaluation can be performed for the new well.

In one embodiment, the existing well module can forecast the performance of the existing well using stored data such as well performance data, well design and completion information, documented procedural information, or a combination thereof. In one embodiment, the existing well module can optimize the performance of the existing well using the stored data. In one embodiment, the existing well module can identify a performance issue associated with the existing well based on the stored data and provide a recommendation for resolving the performance issue associated with the existing well. For example, the recommendation can be a list of technical consultants to help evaluate the performance issue associated with the existing well, a modification to the existing well, or a combination thereof.

In one embodiment, calculating the property of the existing well using the well screening module includes calculating productivity improvement ratios, production indexes, skin calculations, screen erosion predictions, sanding predictions, or a combination thereof.

Another aspect of the present invention includes a computer-implemented method to evaluate a well that is or is to be placed in fluid communication with a subsurface reservoir is disclosed. The method includes accessing a well performance program that includes a new well module, an existing well module, and a well screening module. The new well module can be used to evaluate the performance of a new well to be placed in fluid communication with the subsurface reservoir. The existing well module can be used to evaluate the performance of an existing well that is in fluid communication with the subsurface reservoir. The well screening module can be used to calculate a property of the existing well. Properties of fluid contained within the subsurface reservoir and geological characteristics of the subsurface reservoir are input into the system. The well performance program is run using the input fluid properties and geological characteristics. Evaluating the new well using the new well module includes defining the new well as a horizontal, vertical, directional, or multilateral well. Zonal isolation and a completion types are also defined for the new well. The performance of the new well can then be forecasted. In some embodiments, an economic evaluation can also be performed for the new well. Evaluating the existing well using the existing well module can include forecasting the performance of the existing well, resolving a performance issue associated with the existing well, optimizing the performance of the existing well, or a combination thereof. Calculating the property of the existing well using the well screening module includes calculating productivity improvement ratios, production indexes, skin calculations, screen erosion predictions, sanding predictions, or a combination thereof. A visual display is produced based on one or more outputs from the well performance program.

In one embodiment, the existing well module uses documented procedural information to resolve the performance issue associated with the existing well.

In one embodiment, the existing well module uses documented procedural information to optimize the performance of the existing well.

### BRIEF DESCRIPTION OF THE DRAWINGS

FIG. 1 is a flowchart illustrating steps of a well performance method, in accordance with the present invention.

FIG. 2 is a flowchart illustrating new well workflow steps of a well performance method, in accordance with the present invention.

FIG. 3 is a flowchart illustrating existing well workflow steps of a well performance method, in accordance with the present invention.

FIG. 4 is a flowchart illustrating quick calculation and screening steps of a well performance method, in accordance with the present invention.

FIG. 5 is a schematic diagram of a well performance system, in accordance with the present invention.

### DETAILED DESCRIPTION

Embodiments of the present invention described herein are generally directed to a system and method for well prediction, evaluation and optimization. As will be described herein in more detail, the system and method incorporate procedural information such as industry accepted techniques, best practices, and lessons learned to guide the evaluation and optimization of a well, as well as, predict its production performance in one computerized operation. Long-term well integrity and optimum completion performance are obtained as a variety of well types and completion designs are analyzed for the underlying characteristics of the subsurface reservoir. New wells can be evaluated to ensure they meet performance and economic objectives. Issues related to existing wells can be resolved and the performance of the wells can be optimized. Wells can also quickly be screened to forecast performance and potential failure characteristics of the well.

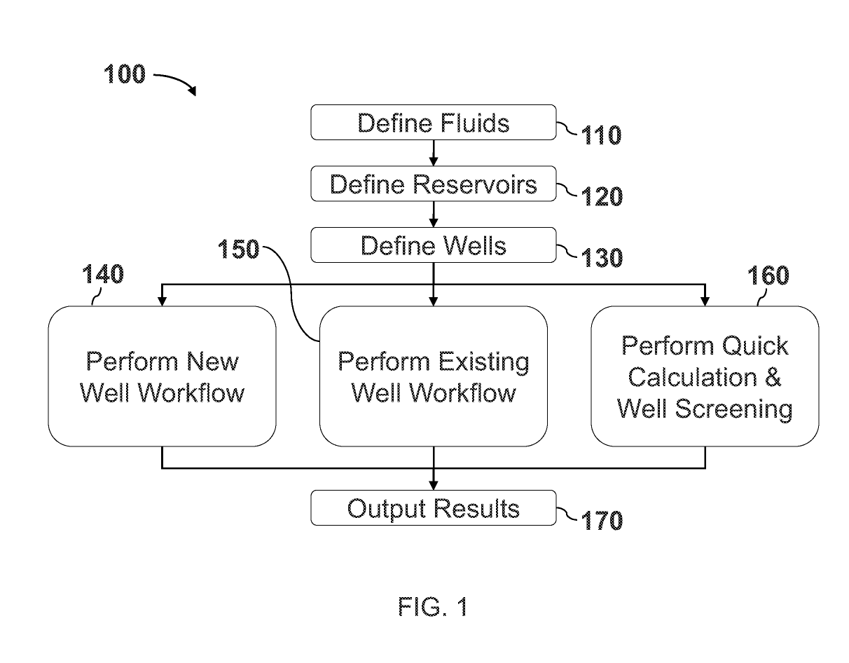

FIG. 1 is a flowchart that describes method 100 for evaluating, predicting and optimizing well performance in accordance with the present invention. Method 100 begins in step 110 by defining the fluids contained within the subsurface reservoir such as oil, natural gas, and water. In some cases, detailed properties corresponding to each of these fluids can also be defined in step 110. For example, the fluid density or API gravity, which is the weight per unit volume of oil as measured by the American Petroleum Industries (API) scale, can be defined. Other fluid properties, such as Viscosity and Pressure-Volume-Temperature (PVT) data, can also be input for fluids in step 110. In step 120, characteristics of the reservoir are defined, such as reservoir drainage characteristics. Step 120 includes determining whether reservoir fluids are trapped in fluid compartments or if they are continuously distributed throughout the reservoir, whether fluid flow paths such as fractures exist within the reservoir, whether the reservoir is homogenous or heterogeneous, whether the reservoir is composed of a single layer or multiple layers, and whether the reservoir is adjacent to a source or sink such as a gas cap or aquifer. Additional reservoir rock properties such as porosity distributions and permeability distributions can also be defined in step 120. Once the fluids and reservoirs are defined in steps 110 and 120, respectively, existing wells, which are wells that have already been drilled and completed such that they are in fluid communication with the subterranean reservoir, are defined in step 130. For example, defining existing wells in step 130 can include inputting characteristics of existing wells associated with the reservoir. This includes defining whether wells are considered horizontal, vertical, directional such that the wells are deviated or slanted from vertical, or multilateral such that the wells have at least one branch stemming away from the main borehole. As will be described in more detail later herein, this step can also include defining completion designs for these wells such that the wells are able to efficiently flow. If a reservoir has no existing wells of interest, step 130 can be skipped.

As shown in FIG. 1, a variety options can be performed once the fluids, reservoirs, and any wells of interest are defined in steps 110, 120, and 130, respectively. New well workflows can be performed in step 140, which allows for evaluation of a newly defined well. As used herein, newly defined wells or new wells are wells to be placed in fluid communication with the subterranean reservoir. Existing well workflows can be performed in step 150, which allows for evaluation of existing wells that were defined in step 130. Quick calculations or well screenings can be performed in step 160. As will be described later herein, step 160 allows for rapid computation of specific well performance characteristics without a more rigorous evaluation of the well being completed, such as in steps 140 and 150. As will be described, quick calculations or well screenings can interface with various software programs or modules to perform such computations. Results to the new well workflows in step 140, the existing well workflows in step 150, and the quick calculations or well screenings in step 160 are output in step 170. The output in step 170 can be in tabular, graphical, or any other form permitted it communicates to the user the results obtained in steps 140, 150, or 160.

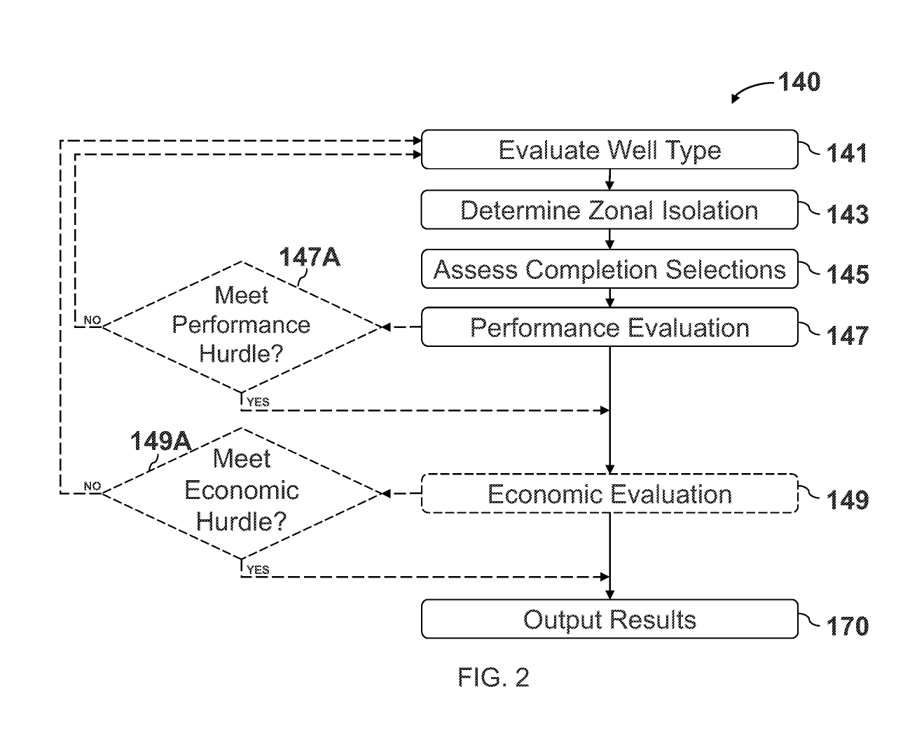

FIG. 2 illustrates an example of new well workflow 140 of method 100, where dashed lines indicate optional steps in this workflow. In this embodiment, new well workflow 140 begins in step 141 by computing the predicted production performances for a variety of well types for the defined fluid and reservoir characteristics. Step 141 can also make preliminary recommendations to the user on the types of wells that should preferably be placed in communication with the subterranean reservoir based on predicted well performances. For example, step 141 can determine the production indexes for a horizontal, vertical, directional, or multilateral well and suggest to the user which wells may be better suited for the defined fluid and reservoir conditions. In step 141, well parameters, such as well length and wellbore radius, can be defined for the selected well type. As the well parameters are varied for a selected well type, the predicted production performance of that well is automatically updated and can be displayed to the user.

In step 143, it is determined whether zonal isolation for a selected well is warranted. If fluids in one reservoir zone are preferably produced separately from fluids in another reservoir zone, then zonal isolation for the well can be implemented. Determination of whether zonal isolation is preferred is generally based on differences in pressure and permeability along the well length, and whether the reservoir is adjacent to a gas cap or aquifer. For example, if the permeability contrast between zones is more than a predetermined order of magnitude, coning is likely to occur in the higher permeability zone. To prevent such coning, zonal isolation for the well can be implemented to isolate the high permeability zone from the low permeability zone, and thus achieve a more uniform production distribution between the two zones. It is common practice within the drilling and completions community to create zonal isolation through appropriate use of casings and packers.

Step 145 includes selecting a completion design for the selected new well so that the well is able to efficiently flow. For example, step 145 includes determining whether a casing or liner is needed by selecting a general completion type, such as a barefoot (open-hole) or cased-hole completion. Such a selection is typically based on a combination of fluid, reservoir, and well factors. For example, if the fluid, reservoir, and well factors indicate that zonal isolation will be needed for the well, either immediately or at some future point, cased-hole completions are typically recommended. If zonal isolation is not necessary, barefoot (open-hole) completions are typically considered adequate. For the selected general completion type, step 145 additionally includes selecting if a sand control mechanism or screening apparatus should be utilized, such as a gravel pack, screen, or expandable screen. A determination of whether a sand control mechanism is recommended for a well is based on factors including the consolidation state, porosity fraction, and rock strength of the formation corresponding to the well inlet, as well as, pressure drawdown characteristics of the well. For example, in one embodiment that includes an unconsolidated formation, if the porosity is less than 20%, the sonic log travel time is less than 50 microseconds, and the ratio of pressure drawdown and rock collapse strength is less than 1.7, sand control is recommended.

By providing additional information such as drilling information, acceptable well life, and the distribution of grain size of the sand or particulates present in the formation, a recommendation can be provided to the user on which sand control mechanisms may be better suited for sand management compared to others. Probability distribution coefficients, abbreviated as D_{%}, represent the grain size distribution. Common distribution coefficients are D₁₀, D₄₀, D₅₀, D₉₀, and D₉₅. From these probability distribution coefficients, various ratios, such as D₁₀/D₉₅ and D₄₀/D₉₀ can be calculated to represent the degree of sorting of the formation. Alternatively, the grain size distribution can be characterized using a mesh size. For example, a 325 mesh screen allows particles being less than 44 microns to pass through the mesh screen.

In one embodiment, an expandable sand screen is recommended for the well if the grain size distribution of theD₁₀/D₉₅ ratio is less than 10, the D₄₀/D₉₀ ratio is less than 5, the Sub 44 micron value is greater than 5 percent, or a combination thereof. In this embodiment, additional considerations can include having no reactive shale present, screens being able to reach total depth (TD) with water based mud, the open-hole size being less than 8.5 inches, drill cuttings collection and disposal are available, the well not being a subsea well, and the projected well life being less than 5 years. Open-hole gravel packs and cased-hole FracPacs are also examples of completion types that can be recommended to the user in step 145. A prediction related to the failure of a well due to sand erosion can also be provided to the user in step 145. All such completion types and sand control mechanisms are well known in the field of well design.

A performance evaluation for the new well is computed in step 147. For example, a common method of evaluating the performance of a well is by computing a production forecast for the well. The well inlet flow rate can be obtained using the following equation:

Qᵢ=PI(Pₑ−P_{wf}) Equation (1)

where the well inlet flow rate is represented by Qᵢ, the productivity index of the well by PI, the reservoir pressure by Pₑ, and the well inlet or bottom-hole flowing pressure by P_{wf}. Using depletion rate analysis, a production forecast that accounts for the decrease in petroleum extraction over time can be obtained using the following equation:

$$Q ( t ) = \frac{{Q}_{i}}{{( 1 + {bD}_{i} t )}^{\frac{1}{b}}} \qquad Equation ( 2 )$$

where b represents the decline exponent that describes the change in the production decline rate D with time t. Accordingly, the decline exponent b influences the rate at which the well will produce and thus, directly affects the production forecast. The decline exponent b generally has the limits of 0 and 1, where the decline is considered exponential for b=0, harmonic for b=1, and hyperbolic for 0<b<1. Dᵢ represents the initial production decline rate at t=0 and can be expressed mathematically as:

$${D}_{i} = {lim}_{t \to 0} \{ \frac{Δ Q / Δ T}{Q} \} \qquad Equation ( 3 )$$

The production forecasts obtained using Equation (2) can be output in the form of cumulative oil produced, the rate of oil produced, or as a production profile comparing the oil produced over a time period. One skilled in the art will appreciate that other methods of evaluating the performance of the new well, such as determining the expected time to well failure, can alternatively be performed in step 147. In some instances, it is determined whether the performance of the well fulfills a performance objective or hurdle, as shown in step 147A in FIG. 2. For example, this hurdle can be a predefined minimum amount of oil production from the well or other performance criteria that the well must meet. If the new well does not meet the performance hurdle, the user is returned to step 141 such that the new well can be reevaluated. If the new well meets the performance hurdle, an economic evaluation of the new well can additionally be performed or the results of the performance evaluation can be output in step 170.

An economic evaluation of the well, shown in dashed line in FIG. 2, can be performed in step 149. One common method to evaluate the economics of a new well is by calculation of Return of Capital Employed, which compares the earnings or net profit expected from the new well with the capital investment needed for the new well. Other known economic evaluation methods include, but are not limited to, Net Present Value, Return on Assets, Return of Average Capital Employed, and Return on Investment. In some instances, it is determined whether the economics of the new well fulfills an economic objective or hurdle, as shown in step 149A in FIG. 2. For example, this hurdle can be a predefined minimum Return of Capital Employed from the well or other economic criteria that the well must meet. If the well does not meet the economic hurdle, such that it is not in an acceptable profitable range, the user is returned to step 141 so that the new well can be reevaluated. If the well meets the economic hurdle, such that it is in an acceptable profitable range, the results of the performance evaluation, the economic evaluation, or a combination of both evaluations are output in step 170.

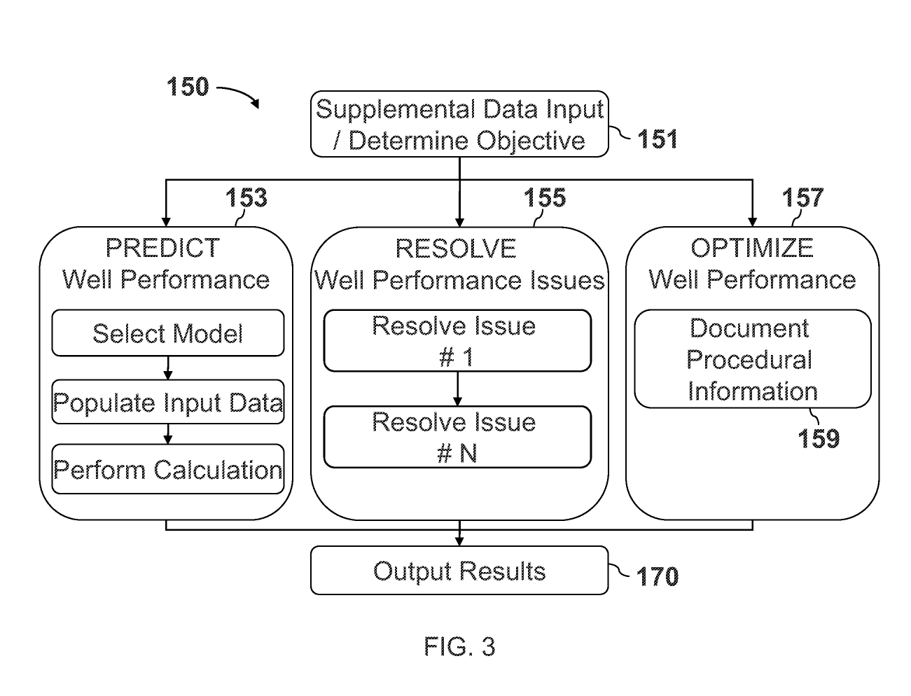

FIG. 3 illustrates an example of existing well workflow 150 of method 100. In this embodiment, existing well workflow 150 begins in step 151 where inputs are required from the user. In step 151, the operator or user is asked a plurality of questions in efforts to obtain information about the existing well. For example, in step 151 the user could be asked if well testing or production logging data is available, whether the well is a flowing well or a pumping well, or whether the well has experienced coning issues. The user can input new or revised data for the existing well or surrounding reservoir in step 151. The user also determines the objective to be performed in the existing well workflow 150. For example, based on the responses to the questions in step 151, it is determined whether the objective is to proceed with predicting the existing well's performance (step 153), resolving performance issues associated with the existing well (step 155), or optimizing the existing well's performance (step 157).

If the user selects to predict the existing well's performance in step 151, step 153 is initiated. Step 153 includes selecting an appropriate model, populating input data, and performing calculations. For example, based on the fluid, reservoir, well configuration information provided in steps 110, 120, and 130, as well as any additional information provided in step 151, a projected production rate can be calculated. In some instances, step 153 interfaces with external software to perform such calculations. For example, for a simple open-hole or cased-hole completion, PROSPER could be used to predict production. For a well with a slotted liner or stand alone screen, NETool, which is a well performance and completion design tool distributed by AGR Petroleum Services headquartered in Oslo, Norway, could be used to predict production. Once the calculations are completed, the results are outputted in step 170.

If the user selects to resolve issues associated with the existing well in step 151, step 155 is initiated. Each issue identified in step 151 is systematically displayed to the user such that each issue is resolved separately, the user can easily navigate between issues, and the user can close issues that are no longer relevant or have already been resolved. Preferably, the issues are displayed to the operator in a logical order, such as by significance of the issue. Once all issues pertaining to the existing well are resolved in step 155, a recommendation is outputted in step 170. The recommendation can include reporting a summary of the issues and resolutions, advising the user to meet with a technical or subject matter expert, providing the user a list of questions to ask the expert, advising the user to perform additional calculations using certain programs, or suggesting modifications to the well.

If the user selects to optimize the existing well's performance in step 151, step 157 is initiated. The optimization procedure in step 157 incorporates procedural information such as industry accepted techniques, best practices, and lessons learned to guide the optimization of a well. For example, step 157 can include optimization of the well's production rate or Rate of Return. Step 157 could alternatively include rigorous optimization calculations or a sensitivity analysis so that a predetermined “most desirable” condition can be obtained. Any best practices or lessons learned during step 157 are recorded as procedural information in step 159. The procedural information can be utilized for future well optimization in step 157 or for resolving well issues in step 155. Results from step 157, which are outputted in step 170, include reporting suggested well modifications to optimize the performance of the well.

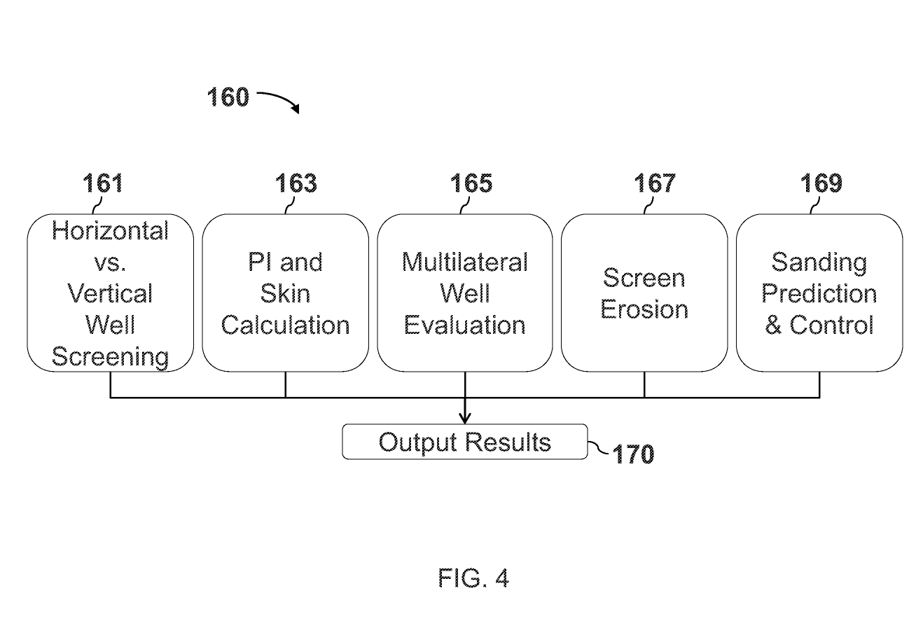

FIG. 4 illustrates examples of quick calculations and well screenings that can be performed in step 160 of method 100. Operation 161 computes the production performance of a horizontal well and a vertical well for the defined fluid and reservoir characteristics. For example, Equations (1)-(3) can be used for computing the production performance of a well. In some embodiments, operation 161 performs an economic evaluation calculation for a well such as the methods described in step 149 of method 140. PROSPER or NETool are examples of external software tools that can be used to perform such calculations in step 160. The results computed in operation 161 are then outputted in step 170. For example, the results can be production indexes for the horizontal and vertical wells or they can be a ratio of productivity improvement, which is the value of the production index for the horizontal well divided by the production index for the vertical well.

Operation 163 is capable of computing the production index and skin factor of a well for the defined fluid and reservoir characteristics. The results computed in operation 163 are typically outputted as numerical values in step 170. Operation 165 computes the performance of a multilateral well for the defined fluid and reservoir characteristics. The result computed in operation 165 typically is a production index for the multilateral well, which is outputted in step 170.

If a well is completed with a screen, operation 167 can be utilized to compute the degradation of the screen to predict a potential failure of the well due to sand erosion. Sanding prediction and control operation 169 can be utilized to predict sand production within the well. For example, based on factors including the consolidation state, porosity fraction, rock strength and grain distribution of the formation corresponding to the well inlet, as well as, pressure drawdown characteristics of well, a determination can be made of whether the well will produce sand. Additionally, operation 169 can recommend that certain sand control mechanisms may be better suited for controlling the production of such sand. One skilled in the art will appreciate that other quick calculations and screening modules or applications can be performed in step 160 of method 100.

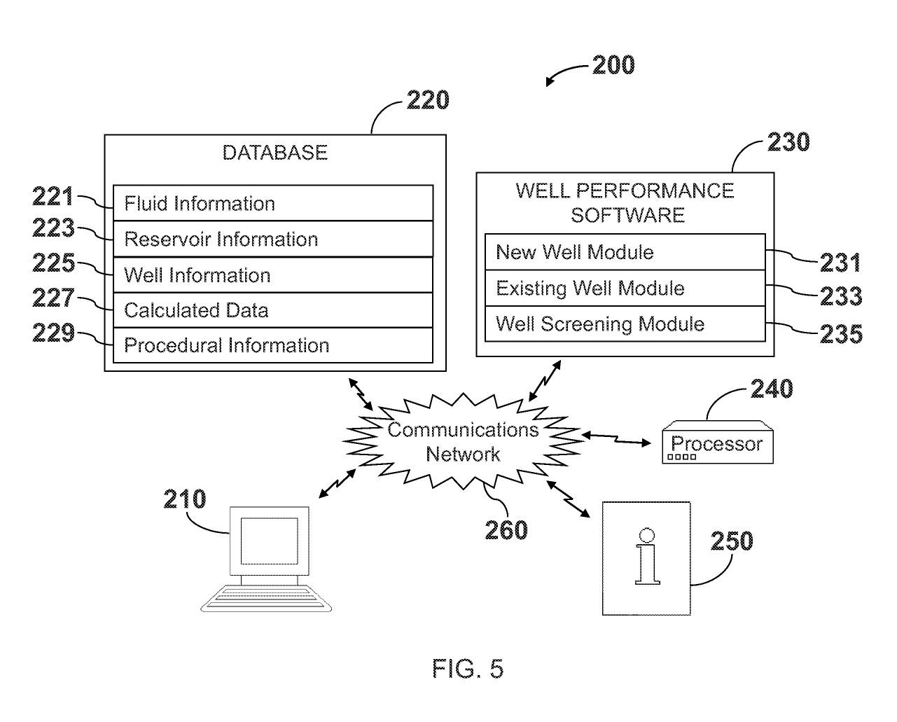

FIG. 5 illustrates system 200 that can be used to perform method 100 for evaluating, predicting and optimizing well performance in accordance with the present invention. System 200 includes user interface 210, such that an operator can actively input information and review operations of system 200. User interface 210 can be any means in which a person is capable of interacting with system 200 such as a keyboard, mouse, touch-screen display, or voice-command controls. Input that is entered into system 200 through user interface 210 can be stored in a database 220. Additionally, any information generated by system 200 can also be stored in database 220. For example, database 220 can store user-defined parameters, as well as, system generated computed solutions. Accordingly, fluid information 221, reservoir information 223, well information 225, calculated data 227, and procedural information 229 are all examples of information that can be stored in database 220.

System 200 includes software 230 that is stored on a processor readable medium. Current examples of a processor readable medium include, but are not limited to, an electronic circuit, a semiconductor memory device, a ROM, a flash memory, an erasable programmable ROM (EPROM), a floppy diskette, a compact disk (CD-ROM), an optical disk, a hard disk, and a fiber optic medium. As will be described more fully herein, software 230 includes a variety of software modules including, but not limited to, new well module 231, existing well module 233, and well screening module 235. Processor 240 interprets instructions to execute software 230, as well as, generates automatic instructions to execute software for system 200 responsive to predetermined conditions. Instructions from both user interface 210 and software 230 are processed by processor 240 for operation of system 200. In some embodiments, a plurality of processors can be utilized such that system operations can be executed more rapidly.

In certain embodiments, system 200 can include reporting unit 250 to provide information to the operator or to other systems (not shown). For example, reporting unit 250 can be a printer, display screen, or a data storage device. However, it should be understood that system 200 need not include reporting unit 250, and alternatively user interface 210 can be utilized for reporting information of system 200 to the operator.

Communication between any components of system 200, such as user interface 210, database 220, software 230, processor 240 and reporting unit 250, can be transferred over a communications network 260. Communications network 260 can be any means that allows for information transfer. Examples of such a communications network 260 presently include, but are not limited to, a switch within a computer, a personal area network (PAN), a local area network (LAN), a wide area network (WAN), and a global area network (GAN). Communications network 260 can also include any hardware technology used to connect the individual devices in the network, such as an optical cable or wireless radio frequency.

In operation, system 200 is populated with input including fluid information 221, reservoir information 223, and well information 225. As previously described, fluid information 221 includes defined fluids and respective parameters contained within the subsurface reservoir, reservoir information 223 includes defined characteristics of the reservoir, and well information 225 includes defined well designs and configurations. For example, fluid information 221 can be populated according to step 110 of method 100, reservoir information 223 can be populated according to step 120 of method 100, and well information 225 can be populated according to step 130 of method 100.

The user can then select to perform a variety of operations once the fluids, reservoirs, and wells have been defined. For example, the user can select to evaluate a new well using new well module 231. New well module 231 performs the new well workflow in step 140 of method 100. Alternatively, the user can select to evaluate an existing well using existing well module 233. Existing well module 233 performs the existing well workflow in step 150 of method 100. In both new well module 231 and existing well module 233, the user can utilize fluid information 221, reservoir information 223, and well information 225 to compute the performance of a well. Existing well module 233 can additionally resolve existing well issues and perform optimization of the well utilizing stored procedural information 229. The user can also forego a complete well evaluation and alternatively select to perform a specific well calculation using well screening module 235. Well screening module 235 performs the quick calculations or well screenings in step 160 of method 100.

Regardless of which module is selected, computed data is stored in database 220 under calculated data 227. For example, calculated data 227 can include production forecasts, economic forecasts, screen erosion predictions, sanding predictions, skin calculations, and production indexes (PI) for the well. New well module 231, existing well module 233, and well screening module 235 are each capable of interfacing with other external systems or well applications (not shown) to perform such calculations. Interfacing includes exporting data needed by the systems to perform the calculations and importing the results of the performed calculations via communications network 260 such that they can be displayed by system 200.

Accordingly, reservoir and well properties can be established in one computerized operation using system 200 such that a well can reliably and efficiently be evaluated. New wells can be evaluated using new well module 231 to ensure they meet performance and economic objectives. Further, new well module 231 ensures long-term well integrity and optimum completion performance are obtained as a variety of well types and completion designs are analyzed for the underlying characteristics of the subsurface reservoir. Using existing well module 233, existing wells can be evaluated and optimized by utilizing documented procedural information. Existing well module also guides the user through resolving any well issues associated with existing wells. Well screening module 235 quickly screens wells to forecast well performance and potential failure characteristics of the well.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention.

What is claimed is:

1. A system to evaluate a well that is in fluid communication with a subsurface reservoir, the system comprising:
a user control interface to input information, the inputted information including geological characteristics of a subsurface reservoir, and properties of fluid contained within the subsurface reservoir;
a database configured to receive and store data comprising the information inputted from the user control interface;
a computer processor configured to receive the stored data from the database and to execute a software program;
the software program comprising:
a new well module to evaluate a performance of a new well to be placed in fluid communication with the subsurface reservoir;
an existing well module to evaluate a performance of an existing well that is in fluid communication with the subsurface reservoir, and
a well screening module to calculate a property of the existing well; and
a visual display for displaying an output from at least one of the new well module, the existing well module, and the well screening module of the software program.

2. The system of claim 1 wherein the new well module is configured for:
selecting the new well from a group consisting of a horizontal well, a vertical well, a directional well, and a multilateral well;
defining zonal isolation for the new well;
defining a completion type for the new well; and
forecasting the performance of the new well.

3. The system of claim 1 wherein the new well module is configured for performing an economic evaluation of the new well.

4. The system of claim 1 wherein:
the stored data further comprises data associated with the existing well; and
the existing well module is configured for forecasting the performance of the existing well responsive to the stored data.

5. The system of claim 1 wherein:
the stored data further comprises data associated with the existing well; and
the existing well module is configured for:
identifying a performance issue associated with the existing well responsive to the stored data; and
providing a recommendation for resolving the performance issue associated with the existing well.

6. The system of claim 5 wherein the recommendation comprises providing a list of technical consultants to help evaluate the performance issue associated with the existing well.

7. The system of claim 5 wherein the recommendation comprises a modification to the existing well.

8. The system of claim 1 wherein:
the stored data further comprises documented procedural information; and
the existing well module is configured for using the documented procedural information to resolve a performance issue associated with the existing well.

9. The system of claim 1 wherein:
the stored data further comprises documented procedural information; and
the existing well module is configured for using the documented procedural information to optimize the performance of the existing well.

10. The system of claim 1 wherein the well screening module is configured for calculating at least one of the following items selected from a group consisting of productivity improvement ratios, production indexes, skin calculations, screen erosion predictions, and sanding predictions.

11. The system of claim 1 wherein the output from the software package is selected from a group consisting of a result to a performance evaluation of the new well, a result to an economic evaluation of the new well, a result to a performance evaluation of the existing well, a calculated property of the existing well, recommendations to resolve a performance issue associated with the existing well, and recommendations to optimize the performance of the existing well.

12. A software program for use in conjunction with a computer having a processor unit, the software program being stored on a readable storage medium and having instructions executable by the processor unit encoded thereon, the software program comprising:
a new well module to evaluate a performance of a new well to be placed in fluid communication with the subsurface reservoir;
an existing well module to evaluate a performance of an existing well that is in fluid communication with the subsurface reservoir, and
a well screening module to calculate a property of the existing well.

13. The software program of claim 12 wherein the new well module is configured for:
selecting the new well from a group consisting of a horizontal well, a vertical well, a directional well, and a multilateral well;
defining zonal isolation for the new well;
defining a completion type for the new well; and
forecasting the performance of the new well.

14. The system of claim 12 wherein the existing well module is configured for forecasting the performance of the existing well.

15. The system of claim 12 wherein the existing well module is configured for:
identifying a performance issue associated with the existing well; and
providing a recommendation for resolving the performance issue associated with the existing well, the recommendation being selected from the group consisting of a modification to the existing well and a list of technical consultants to help evaluate the performance issue associated with the existing well.

16. The system of claim 12 wherein the existing well module is configured for optimizing the performance of the existing well using documented procedural information.

17. The software program of claim 12 wherein the well screening module is configured for calculating at least one of the following items selected from a group consisting of productivity improvement ratios, production indexes, skin calculations, screen erosion predictions, and sanding predictions.

18. A computer-implemented method to evaluate a well that is in fluid communication with a subsurface reservoir using a well performance program, the method comprising:
(a) accessing a well performance program, the program including:
(i) a new well module to evaluate a performance of a new well to be placed in fluid communication with the subsurface reservoir;
(ii) an existing well module to evaluate a performance of an existing well that is in fluid communication with the subsurface reservoir; and
(iii) a well screening module to calculate a property of the existing well;
(b) inputting properties of fluid contained within the subsurface reservoir;
(c) inputting geological characteristics of the subsurface reservoir;
(d) running the well performance program using the inputted properties of fluid contained within the subsurface reservoir and the inputted geological characteristics of the subsurface reservoir to perform at least one of the following operations:
(i) evaluating the new well using the new well module comprising:
(1) selecting the new well from a group consisting of a horizontal well, a vertical well, a directional well, and a multilateral well;
(2) defining zonal isolation for the new well;
(3) defining a completion type for the new well; and
(4) forecasting the performance of the new well;
(ii) evaluating the existing well using the existing well module comprising performing at least one of the following operations selected from a group consisting of forecasting the performance of the existing well, resolving a performance issue associated with the existing well, and optimizing the performance of the existing well; and
(iii) using the well screening module to calculate at least one of the following items selected from the group consisting of productivity improvement ratios, production indexes, skin calculations, screen erosion predictions, and sanding predictions; and
(e) producing a visual display responsive to the running the well performance program in step (d).

19. The computer-implemented method of claim 18 wherein the existing well module uses documented procedural information to resolve the performance issue associated with the existing well.

20. The computer-implemented method of claim 18 wherein the existing well module uses documented procedural information to optimize the performance of the existing well.
